(19) United States
(12) Patent Application Publication
(10) Pub. No.: US 2022/0151173 A1
(43) Pub. Date: May 19, 2022

(54) PLANT NURSERY AND STORAGE SYSTEM FOR USE IN THE GROWTH OF FIELD-READY PLANTS

(71) Applicant: Rodney Sidloski, Weyburn (CA)

(72) Inventor: Rodney Sidloski, Weyburn (CA)

(21) Appl. No.: 17/666,467

(22) Filed: Feb. 7, 2022

Related U.S. Application Data
(63) Continuation-in-part of application No. 15/258,219, filed on Sep. 7, 2016.

(51) Int. Cl. A01G 31/02; A01G 9/029

(52) U.S. Cl. CPC A01G 31/02; A01G 9/0295

(57) ABSTRACT

A plurality of freestanding non-porous planting blocks, each containing a plurality of tapered planting cells, are used in conjunction with a water container. Each planting cell has non-permeable sidewalls as well as open top and bottom apertures. The bottom apertures of the planting cells on the bottom surface of the corresponding planting block, will be submersed in water within the container allowing for subirrigation. The container can be an in-ground reservoir or a manufactured container of permanent or portable nature. Plant material placed in the planting cells, with or without planting media, will grow into field-ready plants for storage or harvest. The system is used for economically enhanced plant production of field-ready trees, shrubs, forbs, perennials, vegetables and grasses.

### CROSS-REFERENCE TO RELATED APPLICATIONS

This application is a continuation in part application tracing priority to copending U.S. patent application having Ser. No. 15/258,219 filed on Sep. 7, 2016, the entirety of which is expressly incorporated herein by reference. This application also incorporates by reference the entirety of U.S. patent application having Ser. No. 16/655,838 filed on Oct. 17, 2019.

This invention is in the field of indoor and outdoor plant production, and more specifically discloses a novel system and method for the growth of field ready plants from plant material using a novel sub-irrigation method.

### BACKGROUND OF THE INVENTION

Vast amounts of global forests have been cut down for farmland expansion, timber industry or consumed for fuel, and reforestation programs are significantly limited by the high cost of tree production. In some countries tree availability is so scarce that government often acquires trees for reforestation by hiring personnel to dig up seedlings one by one from the forest for this purpose. Methods of producing high volumes of seedlings for the reseeding of forests and other consumed crops and natural resources at the lowest possible cost would be a desirable outcome.

Western countries suffer high capital infrastructure and high labour costs in indoor tree production and horticulture production due in part to requiring specialized highly trained personnel to operate complex nursery equipment and processes. Tree production operations in southern hemisphere countries typically suffer from extremely high labour requirements, large land spaces for nurseries and very high soil requirements and high transport costs. Cost of labour, machinery and chemical associated with mechanized and manual cultivation and herbicide and fertilizer application in conventional bare root tree seedling field nurseries and for vegetable seedling and food production is a significant cost. If these costs could be reduced or eliminated then the cost of tree production would likewise be greatly reduced.

Container plant production systems in countries with sub-zero climates require costly greenhouse buildings and irrigation/water quality control technology, nutrient control and often PH balancing processes, and sometimes hydroponic infrastructure. In the case of outdoor field nurseries, costly irrigation, and intensive machinery and/or labour for weeding and cultivation or costly mulching to achieve the same end is required. Conventional outdoor nurseries require significant land space that is costly and more so when outdoor nurseries are in the vicinity of urban centers where real estate values are higher. Container plant production methods that relied upon the highest planting density possible to minimize land and requirements and cost and equipment necessities would be positively accepted in industry. Efforts to minimize the cost of labor often involve high cost capital acquisition of computerized watering and shading systems, water purification, nutrient feeding and PH balancing operations. Examples of complex nursery systems can be seen in Canadian patents 2216735 (Takayuanagi), 1122803 (Da Vitoria lobo), 2119043 (Ynohara), and 2382585 (Hessel & Bar-On).

One of the key concepts which it is believed could provide economic efficiency in container plant production of field ready plants would be to find an alternate method of irrigation, rather than top-down irrigation into the containers in which plant material is planted. Top-down irrigation require significant labour, or technology in its place, and results in a reasonable amount of water wastage as well. If there were a way to eliminate or minimize labour or technology costs and minimize water waste this would be widely commercially accepted in the commercial nursery business. The concept which the inventor has chosen as an alternate approach of irrigation of container gardened plants is to sub-irrigate them, rather than irrigating them from the top down. Passive sub-irrigation will result in the minimization of water waste and labour. However, even in the field of sub-irrigation past attempts in the prior art involved significant investments in technology and in our view overly complicated methodology.

Tree seedlings grown in most large scale tree nurseries in cold climate countries with defined seasons have a limited shelf life. That is, most large scale tree production nurseries cater exclusively to the traditional spring and summer planting season after which they discard unsold seedling stock for composting. Solutions are required that create low-cost live tree storage so that end of season tree seedlings do not have to be discarded but kept to be sold in subsequent seasons sometimes as extra value larger tree stock for additional marketing opportunities. At a time when access to low cost trees is at its most critical, some would suggest it wise to create a low cost means of preserving end of season tree stock.

### SUMMARY OF THE INVENTION

As outlined above, the invention is a sub-irrigation plant nursery and storage system, for use in the growth of field ready plants, and a method of growing field ready plants using such a system, which represents an advantage over many aspects of current practices and prior art approaches.

In a first embodiment, the invention comprises a sub-irrigation plant nursery and storage system for use in the growth of field ready plants which comprises two key components. The first key component of the sub-irrigation plant nursery and storage system is a container for holding water, and the second component is a plurality of planting blocks for placement inside the container. Each of the freestanding nonporous planting blocks have a height dimension and a plurality of tapered planting cells extending therethrough for accommodation and growth of plant growth material therein. Each planting cell is tapered from a top aperture at a top surface of the planting block to a bottom aperture on the bottom surface of the planting block, the top aperture being larger than the bottom aperture thereof. The planting cells have water impermeable sidewalls extending from the patent aperture to the bottom aperture, and each of the top aperture and bottom aperture are open.

The system is used by placing the water container and a growing position in a plant growth area, and providing a layer of water to the bottom of the water container sufficient to engage the bottom surface of the planting blocks. The planting cells of each planting block will then be filled with plant growth material, whereby said plant growth material can access water to the bottom aperture of each planting cell without the need for top irrigation. The plurality of planting blocks are placed and positioned within the water container inside the outer perimeter thereof, with no sidewall support being provided to the planting blocks by the walls of the container. The layer of water is maintained in the bottom of the water container throughout the growing season.

When each planting cell of the planting block is filled with plant growth material, the planting block contains no buoyancy enhancing voids. Furthermore, in light of the fact that water ingress to the planting cells within the planting blocks only takes place by the bottom surface of the planting blocks, no specific spacing of the planting blocks within the container in relation to the sidewalls or to adjacent planting blocks, and no other sidewall or positioning guidance for the planting block from the container is included or required.

By placing the planting blocks within the container such that the bottom surface thereof is in contact with water in the container, so that plants growing within the planting block are completely irrigated from the bottom surface of the block without the need for top irrigation—the root system of the plant material within the planting cells will access the water in the container through the bottom aperture of each planting cell. The concept of sub-irrigation is used insofar as the only thing that needs to be done to water all of the plants within the system is to ensure the presence of a sufficient quantity of water within the container, which can be absorbed by the plant material and plants within the planting blocks via their bottom surfaces which are immersed in or floating on the water within the container.

The planting blocks may be made of a non-buoyant material i.e. such that they would sit on the bottom of the water container with the bottom surface thereof in contact or in proximity to the interior surface of the water container. In such a case, the bottom aperture of the planting cells would still permit ingress of water into the planting cells to provide some irrigation to the plant material contained therein. Alternatively planting blocks in accordance with the remainder of the present invention might also be made of buoyant material such that the planting block would float on or in the water contained within the container. Both buoyant and non-buoyant planting blocks are contemplated within the scope of the present invention.

Where plurality of planting blocks is made of a non-buoyant material, it may be desired to position the non-buoyant planting block or planting blocks within the container by at least one block support allowing for easier access of water to the bottom of the planting cells extending therethrough. The at least one block support might consist of legs or similar structure placed beneath the at least one non-buoyant planting block, or in other embodiments might consist of a plurality of ropes or similar rods or extensions across the top of the water container which engaged the non-buoyant planting blocks in a way to hold them in position above the bottom of the interior of the water container.

The planting blocks of the system of the present invention could be many different shapes in terms of the top and bottom surface thereof. From the perspective of packing as many planting blocks as possible into the container, it is explicitly contemplated that the sub-irrigation plant nursery and storage system might use plurality of planting blocks that has a rectangular top surface—with the planting cells likely arranged in a linear grid pattern thereon. Other top surface shapes and placement patterns or matrices for the planting cells within the planting blocks can also be used and any such arrangement will be understood to be contemplated within the scope of the present invention.

In the use of the sub-irrigation plant nursery and storage system, plant growth material can be placed within a planting cell without planting medium, such that at least one field ready plant which grows therefrom grows in air within the planting cell. In other instances, where it is desired to grow the field ready plants within the planting cells within a growth media such as soil or the like, and plant growth material would be placed in a planting cell along with such planting media. The growth of plant growth material and field ready plants either in planting media such as soil, or in air, are both approaches which are contemplated within the scope of the present invention.

The planting cells in the planting blocks could have varying dimensions to accommodate plant material and finished plants of different sizes—the planting cells could for example have a volume in the range of 8 mL to 3200 mL, or any other size depending upon the desired outcome and all such sizes and dimensions will again be understood to be contemplated within the scope of the present invention. Planting blocks of different material or different characteristics and dimensions can all be used within the same water container without departing from the scope of the present invention as well. For example buoyant and non-buoyant planting blocks can be used, planting blocks with cells of more than one size could be used or any number of other different parameters can be varied without departing from the scope of the present invention.

The container of the sub-irrigation plant nursery and storage system might consist of a purpose built or a natural in-ground water reservoir, or in other implementations it could be an above ground or in-ground manufactured container. If it is a manufactured container that might be portable or permanently installed.

One or more field ready plants can be grown in a single planting cell of a single planting block in accordance with the remainder of the system and method of the present invention, depending upon the desired outcome and the nature of plant material placed in a cell. Plant material placed in the growth cells of the planting blocks of the present invention would be selected from at least the group of trees, shrubs, forbs, perennials, vegetables and grasses. Really any type of a plant which it is desired to produce for a field ready planting status and which can be grown from initial plant material could be produced using the system of present invention provide that proper plant material was available.

Once the field ready plants are grown within the planting cells on a planting block in accordance with the remainder of the sub-irrigation plant nursery and storage system of the present invention, the field ready plants can be stored within their respective cells in a planting block until they are ready to be deployed for field planting. The planting block can simply be stored in water within the water container until the transplanting of plants to the field is desired.

It will be understood that many variations on the sub-irrigation plant nursery and storage system of the present invention will be clear to those skilled in the art of horticulture, agriculture and similar product design and all such obvious modifications and enhancements are contemplated to be within the scope of the claims in the present invention.

In addition to a sub-irrigation plant nursery and storage system, the present invention also comprises a method of growing field ready plants using a sub-irrigation plant nursery and storage system which comprises a water container capable of holding water and having sides of the container defining an outer perimeter, along with a plurality of planting blocks each of which comprises a freestanding nonporous block of material having a height dimension and a plurality of tapered planting cells extending therethrough, for accommodation and growth of plant growth material therein. Each planting cell comprises an open top aperture on a top surface of the planting block, a bottom aperture of the bottom surface of the planting block which is smaller in diameter than the corresponding top aperture, and water impermeable site this extending from the top aperture to the bottom aperture thereof.

Using the provided system, the method comprises in a first step placing the water container and a growing position in a plant growth area, and providing a layer of water to the bottom of the water container of only sufficient depth to engage the bottom surface of the planting blocks i.e. the water layer being shallower than the height dimension of the planting blocks. The second step of the method, planting cells of each planting block are filled with plant growth material, whereby said plant material can access water through the bottom aperture thereof without the need for top irrigation. In the next step the plurality of planting blocks are positioned within the water container inside of the outer perimeter thereof, with no sidewall support being provided or required to the planting blocks by the walls of the water container. The layer of water in the bottom of the container is maintained throughout a growing season, and at the conclusion of the growing season, the field ready plants are harvested from the planting cells in the planting blocks for transplant to the field. This simple method of planting and growth of field ready plants from plant material, using a sub-irrigation method, represents a significant enhancement over the current state-of-the-art in this area both in terms of simplicity of equipment and methods employment as well as the overall cost of production of the field right plants in question.

As outlined about with respect to the system of the present invention, the planting blocks might be buoyant or non-buoyant. Non-buoyant planting blocks could potentially sit on the bottom surface interior of the container and access water through the bottom apertures of the planting cells therein, or could be supported above the bottom surface of the container using one or more planting block supports. Where a planting block is buoyant it could float in the water within the container.

Field ready plants can be grown in planting blocks and their planting cells in accordance with the method of the present invention with or without planting medium such as soil within the planting cells. It is explicitly contemplated that the method could grow field ready plants in air within the planting cells, or within soil or growing media.

The method could use planting blocks which have planting cells of more than one size in a particular planting block.

The method could either use an in-ground water reservoir as the water container, or a manufactured container on or in the ground surface can be used. Containers on the ground could use the ground as the interior bottom surface thereof and may or may not also include a water impermeable liner. Ground containers could also be dug into the ground below the approximate planar ground surface, the excavation side walls forming the side walls of the container.

The method of the present invention can be used to grow field ready plants from plant material selected from the group of trees, shrubs, forbs, perennials, vegetables and grasses.

One or more field ready plants can be grown within a plant cell.

Nutritional supplements may or may not be provided to plants within the planting cells beyond those contained in the water. Nutritional supplements can be provided to field ready plants or plant material within the planting cells either by addition of the nutritional supplements to the water within the container, or by application of the nutritional supplements over the top surface of the planting block.

As outlined above, the system and method of the present invention provides for many different embodiments and variants on the core method and approach, of growing field ready plants from plant material in a plurality of planting blocks within a water container, which allows for the plants growing within the planting cells of the planting block to access water for irrigation purposes using a sub-irrigation method, via bottom apertures in the planting cells therein. Many embodiments of the invention could be envisioned as modest enhancements or changes to the underlying method without departing from the scope and intent hereof and it will be understood that all such changes are intended within the scope of the present invention by the inventor.

The sub-irrigation nursery system and method disclosed enables a reasonably low cost indoor or outdoor method of culturing, growing and maintaining container root plants and providing long term live storage of these plants until they are required for sale or use.

### DESCRIPTION OF THE DRAWINGS

To easily identify the discussion of any particular element or act, the most significant digit or digits in a reference number refer to the figure number in which that element is first introduced:

FIG. 1 is a perspective view of one embodiment of a planting block in accordance with the present invention;

FIG. 2 is a partial cross-sectional view of the planting block of FIG. 1, demonstrating the tapered shape of the planting cells therein;

FIG. 3 is a perspective view of one embodiment of the system of the present invention, in which the container is a manufactured water pan;

FIG. 4 is a perspective view of another embodiment of the system of the present invention, in which the container is a manufactured water pan with planting blocks deployed in a high density lane system therein;

FIG. 5 is a perspective view of another embodiment of the system of the present invention in which the container comprises a series of continuous semi-independent segments;

FIG. 6 is a top view of the embodiment of FIG. 5; and

FIG. 7 is a perspective view of another embodiment of the system of the present invention, in which the container is a natural pond;

FIG. 8 is a flowchart demonstrating the steps involved in one embodiment of the method of the present invention; and

FIG. 9 is a flowchart demonstrating the steps involved in an alternate embodiment of the method of the present invention including a post growth plant storage step.

### DETAILED DESCRIPTION OF ILLUSTRATED EMBODIMENTS

As outlined above, the general concept of the present invention is a sub-irrigation nursery system for use in the expedited and low cost production of field ready plants from planting material. Input costs and labour costs for irrigation and periodic attendance on the plants during the growth timeframe is minimized using the system and method outlined herein. It will be obvious to those skilled in the art reviewing this document that there are certain enhancements or modifications that could be made to certain elements of the method without departing from the scope of the intended coverage of this document and all such modifications as would be obvious to one skilled in the art are contemplated within the scope of the present invention.

The sub-irrigation plant nursery and storage system of the present invention comprises two key components. The first component of the system is a water container capable of holding water during the irrigation and plant production method of the present invention, and holding the plurality of planting blocks as outlined in further detail herein. The container will provide a water reservoir into which the plurality of planting blocks of the system can be placed and from which sub-irrigation can be achieved of the various plants being grown in planting cells, through their bottom apertures. Any type of a container capable of retaining water for use in the remainder of the system and method of the present invention is contemplated to be within the scope of the present invention, including inground or naturally occurring containers, or alternatively manufactured containers.

A manufactured container might be manufactured by excavation, in the context of an inground water container reservoir, or might also be a container for placement on or within a ground surface—for example which could be assembled on site and be portable or permanently installed. Any type of a container which can hold a sufficient quantity of water in its base to allow for the sub-irrigation method of the present invention to function when plurality of planting blocks in accordance with the remainder of the present invention is placed therein is contemplated within the scope hereof.

The second component of the system of the present invention is a plurality of planting blocks which can be placed within the water container. The plurality of planting blocks each consist of a freestanding block of a nonporous material and will each have a top surface and a bottom surface with a plurality of planting cells extending therethrough from the top surface to the bottom surface. Planting cells are tapered from a wider top aperture at the top surface to a narrower bottom aperture at the bottom surface. Plants growing within the planting cells can access water within the container via the bottom aperture of their planting cell.

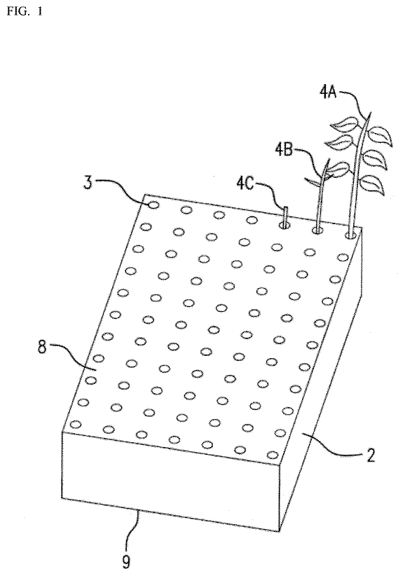

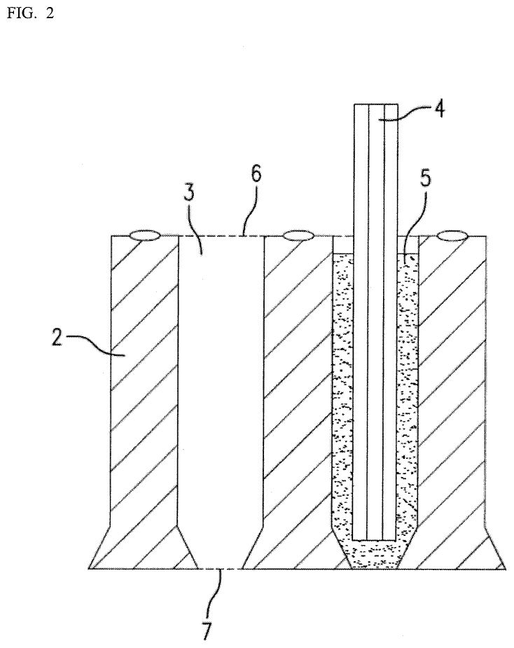

FIGS. 1 and 2 demonstrate one embodiment of the planting block in accordance with the present invention. The planting block 2 is contemplated to be any type of a block of nonporous material in which planting cells 3 can be made or machined in accordance with the remainder of the design. As outlined elsewhere herein, the planting block 2 could either be a buoyant material which would float in the water within the container 1 of the system, or alternatively the planting block 2 could be a non-buoyant material. The top surface 8 and the bottom surface 9 of the planting block 2 are also marked in this Figure.

The planting block 2 contains a plurality of planting cells 3. The planting cells 3 are each an aperture extending through the planting block 2, from the top surface 8 to the bottom surface 9, within which field ready plants can be grown. Each planting cell 3 consists of a larger top aperture 6 and a smaller bottom aperture 7, resulting in a narrowing taper from the top surface 8 to the bottom surface 9. The planting cells 3 as shown in this Figure are arranged in a grid pattern allowing for the planting of a large number of quantities of plant growing material in the planting block 2. The planting cells 3 have water impermeable walls extending from the top aperture to the bottom.

Referring to FIG. 2 there is shown a cutaway detail of two planting cells 3 within the planting block 2 as shown in FIG. 1. Shown in the planting block 2 of this figure are also three plants, at various stages of growth, in three of the planting cells 3. These plants are shown at 4A, 4B and 4C, from smallest to most complete growth.

The planting blocks 2 could be buoyant in which case it would float in the water within a water container of the system, or could also be non-buoyant. In the case of a non-buoyant planting block 2 it may be desired to place a frame or support of some kind beneath the non-buoyant planting block to elevate it above the lower surface and interior of the container to allow for easier access of water from the container to the bottom apertures of the planting cells therein. Alternatively the water may simply creep under the outer edges of the bottom surface 9 of the planting block 2 in a non-buoyant arrangement.

The planting blocks 2 which are shown in the Figures and which are anticipated would be used would likely be rectangular in shape on the top surface, since rectangular or at least rectilinear shaped planting blocks would be the easiest shape to use the most dense population of planting blocks within a container in the system of the present invention. However, beyond the rectangular planting blocks which are shown really any shape of planting block could be used. More than one shape of planting block could also be used in one system of the present invention.

The planting blocks 2 could also be of varying thicknesses. The thickness of the planting block would be dictated primarily by the type of field ready plants which it was desired to grow in accordance with that particular planting block in the system. For example, smaller plants grown from smaller samples of plant growth material could be grown in a thinner planting block which would mean that the planting cells themselves would be shallower. It is specifically contemplated that the planting blocks 2 might have a thickness between 2 inches and 9 inches although it will be understood dependent upon the type of plant material being used or the field-ready plants it is sought to produce that thicknesses even outside of this range could also be used.

There are other parameters of the plurality of planting blocks which could also be varied dependent upon the use or desired outcome with the system and method of the present invention. For example, the planting cells 3 could be of varying diameters. Planting cells 3 within even a single planting block 2 could be of the same diameter and shape, or they could vary such that there were some smaller and some larger planting cells within a particular planting block 3. In addition to the diameter or as a result of the diameter of round planting cells—there could also be planting cells in a particular planting block which are not round that were desired so long as the taper from the top to the bottom was achieved—the volume of the planting cells could vary depending upon the amount of growing media that it was desired to place into a cell, the size of the plant growth material which will be used to start the field ready plants produced, or the size of the root ball it is desired to accommodate within the planting cell once the field ready plant is completed. In the most desirable currently conceived embodiments, planting cells would have a volume in the range of 8 mL to 3200 mL, although it will be understood that a planting cell with virtually any volume are contemplated to be within the scope of the present invention.

In terms of the taper of the planting cells from the top surface to the bottom surface of the planting block, the inner walls of the planting cell could taper down consistently all the way from the top surface of the bottom surface, or as shown in the embodiment of FIG. 2 the taper could be introduced to restrict the bottom of the planting cell by simply placing a tapered closure towards the bottom surface. Any such approach, so long as it relies upon a larger top aperture than a bottom aperture to a planting cell is contemplated to be within the scope of the present invention.

The planting cells 3 could be aligned in any number of different patterns on the surface of plurality of planting blocks 2. For the most dense planting pattern, a linear grid pattern for the planting cells 3 would be the likely best approach, but any type of the arrangement or pattern of the planting cells 3 on the surface of the planting block 2 could be used.

Any number of different types of material could be used to effect sure the planting blocks 2—plastic or other water impermeable materials are the likely products to be used, along with potentially in certain embodiments even cementitious or other moulded materials.

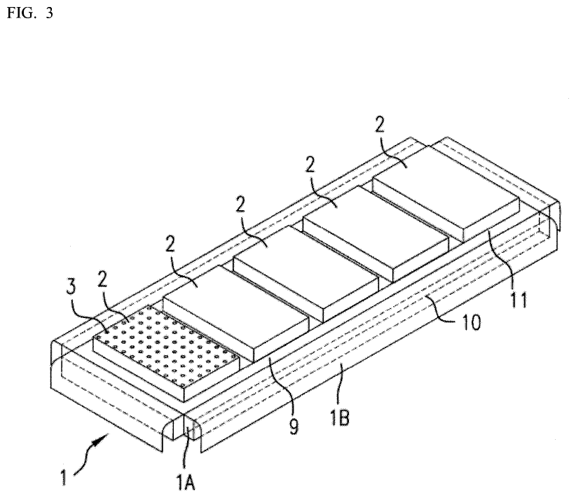

Referring to FIG. 3, the system is shown in which the container 1 comprises a manufactured above ground container. The container 1 in this embodiment is an aboveground frame 1A with a waterproof liner 1B showing therein. Five planting blocks 2 are shown. Only the first planting block 2 has the planting cells 3 demonstrated therein, but as will be understood in accordance with the remainder of the specification, each of the planting blocks 2 would include a plurality of planting cells 3 therein in which field ready plants could be produced. The bottom surface 9 of the planting blocks 2 can also be seen, as is the bottom surface of the container 10.

Certain aboveground containers 1 such as that shown in FIG. 3 could be a manufactured container using the ground as the interior bottom surface of the container. In such cases, manufactured containers at ground level using the ground as the interior surface of the container may or may not also include water impermeable liners to maximize the water efficiency of the system during the growing season.

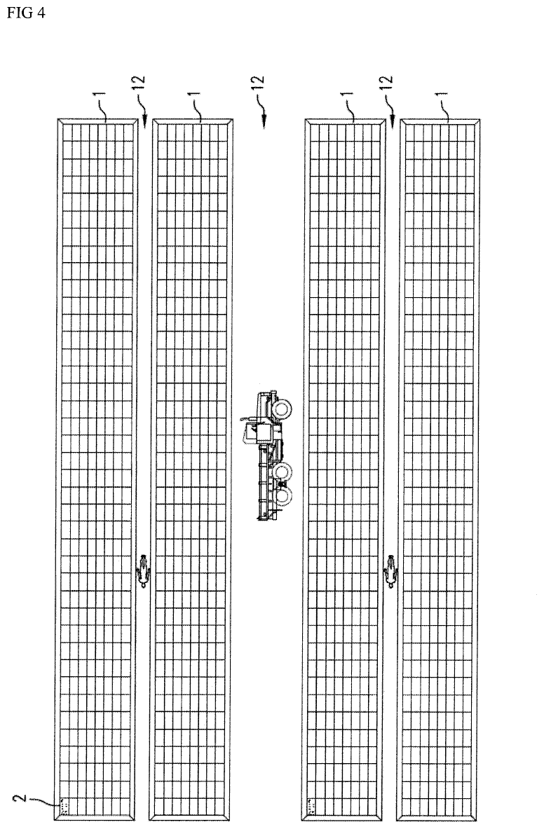

FIG. 4 shows another embodiment of the system of the present invention—in which actually four containers 1 are shown. The embodiment of the system shown in this Figure is intended to show a high density installation in which lanes for access are created between the containers. Four containers 1 are shown, and in the first container 1 a sample of a planting block 2 with a plurality of planting cells therein is demonstrated. The grid patterns drawn on the containers 1 demonstrate all of the planting blocks 2 which could be placed in a single container 1. Based on the grid shown in each container 1 namely 40×8, 320 planting blocks 2 could be deployed in a single container 1 of this nature. Each container 1 being waterproof in its interior, the only thing that needs to be done to irrigate all of the plants and all 320 planting blocks is to simply pour water into the container 1 of a sufficient level to allow for the bottom apertures and bottom surfaces of the planting blocks 2 to access the water within the container 1.

While the system of the present invention eliminates the need for much access by operators to individual planting blocks 2 during the production cycle, the placement of lanes between containers 1 of this size would enhance the ability to access the growth surface of the container 1 as might be required. Three lanes 12 are shown, the centre one of which demonstrates a truck therein, and the top and bottom ones of which show an individual walking down the lane.

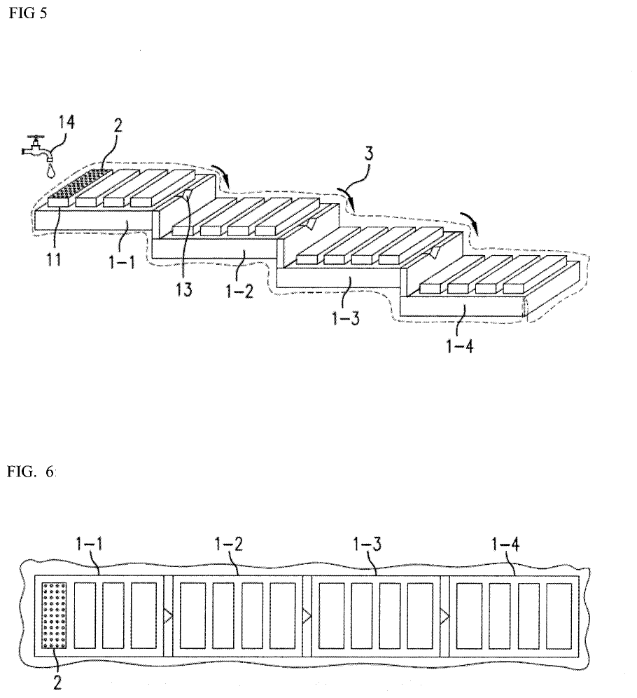

FIGS. 5 and 6 demonstrate another embodiment of the system of the present invention in which the container 1 comprises a four-part container, which can be used on a slope or terrace. It can be seen that a single water spigot 14 can be used to fill the water level in all four containers by simply pouring water 11 into the top container 1-1 from where it can cascade down into the other three containers 1-2, 1-3 and 1-4. This further simplifies the process of filling the water 11 within the container 1 in accordance with the remainder of the method of the present invention. Each of the four sub-containers shown in this Figure includes four planting blocks 2. The planting cells are again only diagrammed in the first planting block but it will be understood that there would be similar planting cells in each planting block 2.

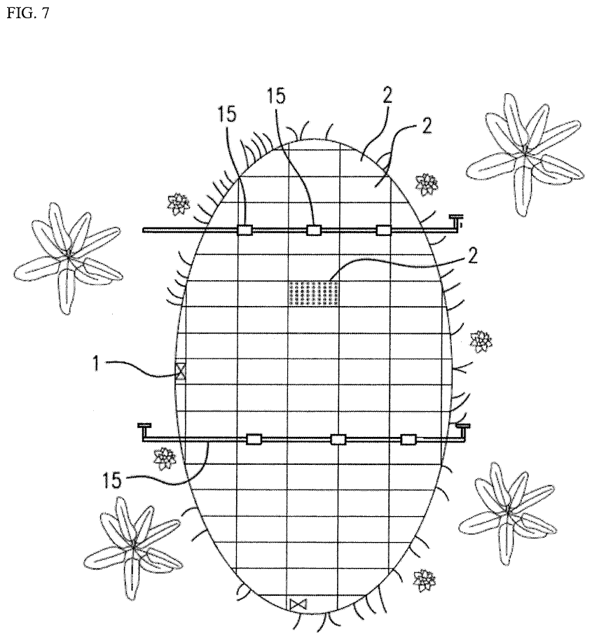

A system in accordance with the present invention could even in certain embodiments comprise a plurality of planting blocks 2 positioned within a naturally occurring water reservoir or container 1. FIG. 7 demonstrates an embodiment of the system of the present invention such as this, in which the planting blocks 2 are deployed in a pattern within a container 1 which is a natural pond. A plurality of planting blocks 2 is shown on the surface of the pond 1. Ropes or supports 15 are shown in two horizontal positions across the pond container 1—the planting blocks 2 could simply be placed into the pond 1 such that they would float and be retained between those supports 15 in one direction. Retention of the planting blocks 2 in only one direction by a unidirectional set of supports 15 is likely in most embodiments sufficient since beyond retaining the planting blocks 2 in general position, it is not necessary to maintain them in a precise floating pattern on the surface of the container 1.

If the plurality of planting blocks 2 was non-buoyant, it may be desired to provide a support that would support the plurality of planting blocks above the bottom surface of the container to allow for easier access of water into the bottom apertures of planting cells therein. The supports could either consist of a frame or legs or the like placed below the planting blocks, or depending upon the nature of the container the supports for positioning the planting blocks within the container might also be frame members of the like which hung down or in proximity from the top of the container such that the planting blocks were defined in their positions by hanging down from this type of support rather than being supported from their base. The use of supports below the bottom surface of the planting blocks, or top-down “hanging” supports which defined the vertical position of the planting blocks 2 within the container 1 are all contemplated within the scope hereof.

In use of the system of the present invention, the planting blocks 2 would be placed within the container 1 with plant growth material in the planting cells 3. Water is placed in the container 1, once plant growing material is placed in the planting cells 3. The plant growing material or plants growing within the planting cells 3 access the water in the container 1 through the bottom apertures of their respective planting cells 3.

Water is maintained within the container 1 throughout a growing season—once the growing season is completed and the plants within the planting cells are field ready they can either be immediately removed for planting or deployment, or they can be stored within the planting blocks 2, so long as they do not outgrow the planting cells, so long as water is maintained within the container 1. The system of the present invention will allow for the densification of the production of field ready plants in reasonably compact land footprints. Labour cost is minimized during plant production, since the only irrigation labour which is required is to intermittently top up the water level within the container rather than needing to water individual plants in planting cells in the planting blocks in question.

### Method Overview:

As outlined, the present invention consists of a sub-irrigation nursery and storage system and method for the growth of field ready plants from plant material using the system including trees, shrubs, forbs, perennials, vegetables and grass, which comprises a container capable of holding water, and a plurality of planting blocks placed within the container and having a top surface and a bottom surface and a plurality of planting cells extending therethrough from the top surface to the bottom surface, wherein each planting cell is tapered from the top aperture on the top surface to the bottom apertures on the bottom surface, the top aperture of the planting cell being larger than the bottom aperture thereof. The planting blocks are freestanding blocks of a nonporous material. The interior walls of the planting cells are water impermeable. The bottom surface of the plurality of planting blocks is capable of contact with water within the container, such that plants growing within the planting block are completely irrigated from the bottom surface of the block and without the need for top irrigation. Using this system, the physical steps of the method of plant production in accordance with the invention outlined herein can now be discussed in further detail.

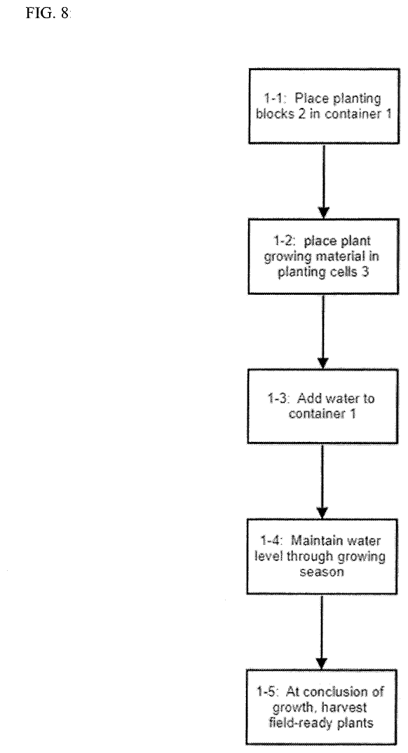

FIG. 8 is a flowchart demonstrating the steps in a first embodiment of the method of the present invention. The first step of this embodiment of the method is the placement of the planting blocks 2 within the container 1. Following, in a planting step shown at 1-2, plant growth material is placed within the planting cells 3 in the plurality of planting blocks 2. Following the planting step, in a sub-irrigation step 1-3 water is placed within the container, such that plant growth material within the planting cells in the planting blocks can access the water through the bottom aperture of the planting cells. In the planting step and the commencement of the growing season, the planting step and the subirrigation step are interchangeable in order i.e. plant growing material could be placed in the planting cells of the planting blocks in advance of the placement of the planting blocks in the water container, or the planting blocks could be placed in the water container first with the plant growing material added thereafter. Either such approach and ordering of these method steps will be understood to be within the scope of the present invention.

Once water is placed in the container, the water level within the container can be monitored and maintained over the plant growing season, until field ready plants are ready to be harvested from the planting cells. The monitoring and maintenance of the water level within the container is shown in step 1-4 in this flowchart. Once field ready plants are present in one or more of the planting cells in the plurality of planting blocks, they can be harvested at the appropriate time by simply removing said field ready plants or plants potentially with a soil or growing media all around their roots, from the respective planting cells—new plant growing material can be planted in the planting cells and further field ready plants prepared. Harvesting of the completed field ready plants, for field planting, is shown at step 1-5. Labour and maintenance cost of the system used in this method is significantly minimized over prior art approaches, since all that needs to be done to irrigate all of the plants that are growing in the planting cells of the plurality of planting blocks within the container is to simply ensure that there is enough water present within the container. Individual plants need not be watered as they passively obtain water through the sub-irrigation method.

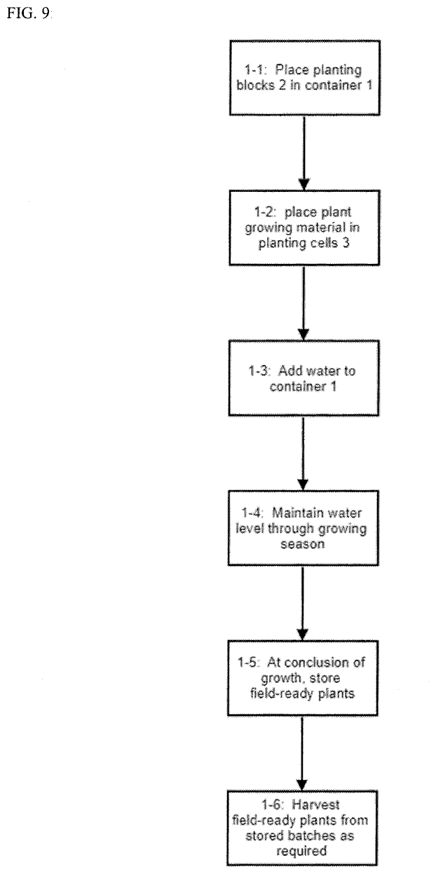

Beyond providing an ability for the sub-irrigation of plant growing material to grow field ready plants, the system and method of the present invention allows for the storage of the grown field ready plants until they are ready to be deployed, sold or used. The field ready plants can be stored in a live format, by simply leaving them in their respective planting cells in the planting blocks in question and continuing to maintain the water level within the container. Referring to the flowchart of FIG. 9 there is shown a flowchart of an alternate method in accordance with the present invention, wherein the basic steps of the plant growth method as shown in FIG. 8 are shown, but a storage step with respect to the field ready classes shown at step 1-5 followed by a harvest as required step at 1-6. Any embodiment of the system or apparatus of the present invention as claimed could be used to the practice of the method.

In some cases plant growth material would be placed in certain planting cells along with planting media such as soil or some other nursery mix. In other cases, plant growing material could be placed within planting cells without any growing media and effectively grown in air.

It will also be understood that one or more field ready plants could be grown within a single planting cell in a planting block, depending upon the nature or type of the plant, the size of the planting cell etc.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. A sub-irrigation plant nursery and storage system for use in the growth of field-ready plants, the system comprising:
a. a water container for retaining water therein, having side walls and a bottom surface; and
b. a plurality of planting blocks each comprising a freestanding block of non-porous material having a top surface, a bottom surface and a height dimension, each planting block comprising a plurality of tapered planting cells extending therethrough for accommodation and growth of plant growth material therein and comprising:
i. an open top aperture on the top surface of the block;
ii. an open bottom aperture on the bottom surface of the block and having a smaller diameter than the top aperture; and
iii. water-impermeable side walls extending from the top aperture to the bottom aperture;
wherein the system is used by:
i. placing the water container in a growing position in a plant growth area;
ii. positioning the plurality of planting blocks within the water container, with no side wall support being provided to the planting blocks by the walls of the water container;
iii. filling planting cells of each planting block with plant growth material, whereby said plant material can access water through the bottom aperture thereof without the need for top irrigation;
iv. providing a layer of water in the bottom of the water container sufficient to engage the bottom surface of the planting blocks; and
v. maintaining the layer of water in the bottom of the container throughout a growing season;
wherein plant growth material growing into field ready plants within the growing season in the planting cells will maintain contact with the layer of water in the water container via the bottom apertures of the planting cells without the need for top irrigation;
wherein no specific spacing of the planting blocks within the container in relation the side walls of the container or adjacent planting blocks and no side wall or other positioning guidance for the planting block from the container is required.

2. The sub-irrigation plant nursery and storage system of claim 1 wherein upon filling each planting cell of a planting block with plant growth material said block contains no buoyancy-enhancing voids; and

3. The sub-irrigation plant nursery and storage system of claim 1 wherein the planting blocks are nonbuoyant.

4. The sub-irrigation plant nursery and storage system of claim 3 wherein the non-buoyant planting blocks are supported within the container by at least one block support.

5. The sub-irrigation plant nursery and storage system of claim 1 wherein the planting blocks are buoyant and can float on the water within the water container.

6. The sub-irrigation plant nursery and storage system of claim 1 wherein the planting blocks have a rectangular top surface and vertical side surfaces.

7. The sub-irrigation plant nursery and storage system of claim 1 wherein the planting cells are arranged in a linear grid pattern on the top surface of the planting blocks.

8. The sub-irrigation plant nursery and storage system of claim 1 wherein plant growth material placed within planting cell further comprises planting media.

9. The sub-irrigation plant nursery and storage system of claim 1 wherein the container is an inground water reservoir.

10. The sub-irrigation plant nursery and storage system of claim 1 wherein the container is a manufactured container.

11. The sub-irrigation plant nursery and storage system of claim 10 wherein the container comprises a container built on the ground using the ground for the bottom surface thereof.

12. The sub-irrigation plant nursery and storage system of claim 11 wherein the container further comprises a water-impermeable liner therein.

13. The sub-irrigation plant nursery and storage system of claim 11 wherein the side walls of the container are manufactured and rest on the ground.

14. The sub-irrigation plant nursery and storage system of claim 11 wherein the container comprises a reservoir dug in the ground with a recessed bottom surface of the container in the ground, and the excavation side walls comprise the side walls of the container.

15. A method of growing field-ready plants using a sub-irrigation plant nursery and storage system comprising:
a. a water container for retaining water therein, having side walls and a bottom surface; and
b. a plurality of planting blocks each comprising a freestanding block of non-porous material having a top surface, a bottom surface and a height dimension, each planting block comprising a plurality of tapered planting cells extending therethrough for accommodation and growth of plant growth material therein and comprising:
i. an open top aperture on the top surface of the block;
ii. an open bottom aperture on the bottom surface of the block and having a smaller diameter than the top aperture; and
iii. water-impermeable side walls extending from the top aperture to the bottom aperture;
said method comprising:
i. placing the water container in a growing position in a plant growth area;
ii. positioning the plurality of planting blocks within the water container, with no side wall support being provided to the planting blocks by the walls of the water container;
iii. filling planting cells of each planting block with plant growth material whereby said plant material can access water through the bottom aperture thereof without the need for top irrigation;
iv. adding a layer of water to the bottom of the water container of sufficient depth to engage the bottom surface of the planting blocks;
v. maintaining the layer of water in the bottom of the container throughout a growing season; and
vi. at the conclusion of the growing season, harvesting the field-ready plants from the planting cells in the planting blocks for transplant to the field;
wherein plant growth material growing into field ready plants within the growing season in the planting cells will maintain contact with the layer of water in the water container via the bottom apertures of the planting cells without the need for top irrigation; and
wherein in light of water ingress to the planting block only taking placing via the bottom surface thereof, no specific spacing of the planting blocks within the container in relation the side walls of the container or adjacent planting blocks and no side wall or other positioning guidance for the planting block from the container is required.

16. The method of claim 15 wherein the sub-irrigation plant nursery and storage system comprises the system of any one of claims 1 to 14.

17. The method of claim 15 wherein upon filling each planting cell of a planting block with plant growth material said block contains no buoyancy-enhancing voids.

18. The method of claim 15 wherein nutritional supplements are provided to plants within the planting cells by addition of said nutritional supplements to the water within the container.

19. The method of claim 15 further comprising storing the field ready plants within the planting blocks at the end of the growth season, either within or outside of the container, until the harvesting of said field-ready plants for transplant is desired.

20. The method of claim 15 wherein the plant material is selected from the group of trees, shrubs, forbs, perennials, vegetables and grass.
